(19) United States
(12) Patent Application Publication
(10) Pub. No.: US 2004/0101347 A1
(43) Pub. Date: May 27, 2004

(54) Ergonomic portable multi-purpose cleaning device

(76) Inventor: Morris Luther Beard, Brooklyn Park, MN (US)

Correspondence Address: Fernando N. Tibayan, Jr., 6633 10th Avenue South, Richfield, MN, 55423, US

(21) Appl. No.: 10/305,721

(22) Filed: Nov. 27, 2002

(51) Int. Cl. B43M 11/06; B43K 5/02; A47L 13/26

(52) U.S. Cl. 401/139; 401/188 R; 401/261

(57) ABSTRACT

A cleaning device comprising a reservoir for holding cleaning fluid, a cleaning assembly attached to the reservoir, and a dispensing means connected to the reservoir. In one embodiment, the reservoir is domed shaped to fit into the user's hand and has notches about its periphery to facilitate a firm grip. The cleaning assembly is detachably connected to reservoir. The cleaning surface of the cleaning assembly can be constructed from various materials such as plastic filament or sponge. The dispensing means is comprised of a nozzle, a plunger, and a choice of two tubes that extend into the reservoir. Apertures formed on the reservoir and cleaning assembly allow finger operation of the plunger and direct the fluid onto targeted areas. The device can be used to apply and work the fluid into the surface to be cleaned in one continuous motion without loss of contact with the surface.

### BACKGROUND

Presently, there are three conventional ways to apply cleaning fluids to surfaces. First, the fluid can be applied by squirting or spraying directly on the surface to be cleaned. The fluid is then wiped from the surface using a sponge, rag, or cloth. When cleaning a vertical surface, this method can lead to unwanted streaking due to the running of fluid before a cloth or rag can be applied. In addition, the fluid can evaporate before it is wiped. This leads to unnecessary waste and the purchase of additional fluid.

Second, the cleaning fluid can be poured or sprayed onto a sponge, rag, or cloth, then applied in a wiping motion to the surface to be cleaned. However, if too much fluid is placed on a rag or cloth, excess fluid can drip from the rag and cause streaking. Also, fluid can drip from the cloth to floor causing stains and potential slip hazards. If too little fluid is used, more fluid must be dispensed in successive applications, thus increasing the danger of spillage. In both of the aforementioned techniques, the fluid that is absorbed into the cloth or rag comes into direct contact with the user's hands and skin. Health effects can vary from mild to severe based upon the chemicals used and the sensitivity of the person. Lessening the incidence of direct contact with the chemicals as well as decreasing the amount of cleaning fluid used can help reduce potential health risks, especially over a long period of time.

Finally, sponge applicators, such as those used in shoe polishing or dishwashing, are pressed against a surface as the fluid is dispensed through the sponge material of the applicator. By nature, this technique cannot be used on delicate, highly pliable surfaces because added pressure must be applied to the surface in order for the cleaning fluid to be dispensed through the applicator. In this state, the applicator is already saturated with fluid and its absorbing power is nullified. This results in fluid dripping from the applicator and streaking. A cloth or rag must often be used in conjunction with the sponge applicator in order to wipe up the resulting excess.

Information relevant to attempts to address these problems can be found in U.S. Pat. Nos. 6,048,583; 5,054,945; 4,776,716; 6,010,268; 4,9530,999; Des. 316,318, and; Des. 386,852. However, each one of these references suffers from one or more of the following disadvantages:

a) Cannot fit inside an automobile's glove compartment and other compact storage spaces.

b) Dependent upon an external power source.

c) Cannot be used to apply and work the fluid into the surface to be cleaned in one continuous motion without loss of contact with the surface.

d) Causes streaking, excess fluid runoff, and dripping.

e) Not designed to clean both vertical and horizontal surfaces.

f) Does not allow precise placement of the cleaning fluid to the targeted surface in an amount easily controllable by the user.

g) Cleaning surface of cleaning assembly does not detach from fluid reservoir for separate and more compact storage.

h) Does not provide a choice of cleaning assemblies with unique accompanying cleaning surfaces that attach to the same, ergonomic cleaning device.

i) Does not provide a choice of actuator assembly tubes which prolong the need to refill the fluid reservoir when cleaning substantially vertical or horizontal surfaces.

For the foregoing reasons, there is a need for an ergonomic multi-purpose cleaning device that is compact, portable, and refillable which reduces spillage and streaking of cleaning fluid and allows the user to apply and wipe fluid on a wide variety of horizontal and vertical surfaces in one continuous motion without removing the device from the surface to be cleaned.

### SUMMARY

The present invention is directed to a device that satisfies these needs. An ergonomic, portable, multi-purpose cleaning device having features of the present invention comprises a reservoir for containing cleaning fluid, a cleaning assembly in fluid communication with the reservoir having at least one cleaning surface, and a dispensing means connected to the reservoir for dispensing the cleaning fluid stored in the reservoir.

The reservoir is shaped to conform to a user's hand, making the device an ergonomic tool. The outside edge of the reservoir has at least one groove shaped to receive at least one finger of a user's left or right hand for added control when cleaning. To add comfort to a user's grip and to allow more fluid to be stored, the reservoir is generally domed shaped.

In one embodiment of the invention, the reservoir has at least one locking means engagable with at least one corresponding and complimentary locking means on the cleaning assembly. In this manner, the cleaning assembly is detachably fastened to the reservoir.

The cleaning assembly is comprised of at least one cleaning surface and at least one cleaning assembly connecting surface. The cleaning assembly is designed to be detachable and interchangeable to fit the user's cleaning needs. Cleaning surfaces such as sponge foam, flag brush bristles, and nylon wool can be used in constructing the cleaning assembly.

A plunger is used to spray cleaning fluid stored in the reservoir onto the surface to be cleaned. There are two tubes that are associated with the plunger that can be chosen by the user according to the cleaning task. Each tube extends from the outlet nozzle of the plunger into the reservoir. The tube designed for use on horizontal surfaces is angled at about 90 degrees towards the surface to be cleaned at its distal end, thus prolonging the need to refill the device. For vertical surfaces, a generally straight tube can be selected making refilling less frequent.

In one version of the invention, the reservoir has at least one peripheral slot to allow operation of the plunger. The nozzle of the plunger, the reservoir's peripheral slot, and a peripheral slot formed in the cleaning assembly are aligned so that fluid from the nozzle can be concentrated and directed to the intended surface and excess fluid can be collected by the cleaning surface of the cleaning assembly.

In another version of the invention, the nozzle of the plunger is completely surrounded by apertures in both the reservoir and the cleaning assembly. This configuration allows fluid to be sprayed directly to a targeted surface but prevents the fluid from reaching areas not intended by the user.

The multi-purpose cleaning device can be made available as a kit comprising:

a) a reservoir

b) a cleaning assembly or a selection of cleaning assemblies that can be detachably fastened on the reservoir. The cleaning surface of each cleaning assembly can be constructed of materials suited to fit the user's needs. Examples of cleaning surface materials that be used are sponge foam, flag brush bristles, and nylon wool.

c) a plunger with at least one tube that extends from the outlet nozzle of the plunger into the reservoir of the device. If the surface to be cleaned is substantially horizontal, a tube could be chosen that is angled at about 90 degrees towards the surface to be cleaned at the tube's distal end to prolong the need to refill the reservoir. If the surface to be cleaned is substantially vertical, a tube could be chosen that is generally straight, thus increasing the reservoir refilling interval.

d) a cleaning fluid or selection of cleaning fluids such as glass cleaners and rubber and vinyl protectorants.

### DRAWINGS

These and other features, aspects, and advantages of the present invention will become better understood with regard to the following description, appended claims, and accompanying drawings where:

FIG. 1 shows a perspective view of a version of the invention shown cleaning a vertical surface

FIG. 2 shows an exploded perspective view of a version of the invention.

FIG. 3 shows a top plan view of the cleaning assembly of a version of the invention.

FIG. 4 shows a side view of a version of the assembled invention shown along lines 4-4 of FIG. 3.

FIG. 5 shows a bottom plan view of the reservoir base of a version of the assembled invention.

FIG. 6 shows a top plan view of the connecting surface of the cleaning assembly of a version of the assembled invention.

FIG. 7 shows a sectional view taken along lines 7-7 of FIG. 6.

FIG. 8 shows a bottom plan view of the cleaning surface of the cleaning assembly of a version of the assembled invention.

FIG. 9 shows a sectional view of the reservoir of a version of the invention shown with the dispensing means.

FIG. 10 shows a sectional view of a version of the assembled invention taken along lines 10-10 of FIG. 1.

FIG. 11 shows an alternate bottom plan view of the cleaning assembly of a version of the invention.

FIG. 12 shows an enlarged detailed view of the cleaning assembly shown with a wire cleaning surface.

FIG. 13 shows an enlarged detailed view of the cleaning assembly shown with a screen cleaning surface.

FIG. 14 shows an enlarged detailed view of the cleaning assembly shown with a felt cleaning surface.

FIG. 15 shows a bottom plan view of the reservoir base showing an alternate male connecting detail complementary to a female connecting detail on the connecting surface of the cleaning assembly.

FIG. 16 shows a top plan view of the connecting surface of the cleaning assembly showing an alternate female connecting detail complementary to a male connecting detail on the reservoir base of the reservoir.

### DESCRIPTION

In order to provide a better understanding of the invention, one embodiment of the invention will now be described in detail. Frequent reference will be taken to the drawings. Reference numbers will be used to indicate certain parts and locations in the drawings. The same reference numbers will be used to indicate the same parts and locations throughout the drawings unless otherwise indicated.

It is to be understood that the preferred embodiment is but one form and configuration the invention can take. This detailed description is neither intended nor does it limit the invention, which is solely defined by the claims set forth herein.

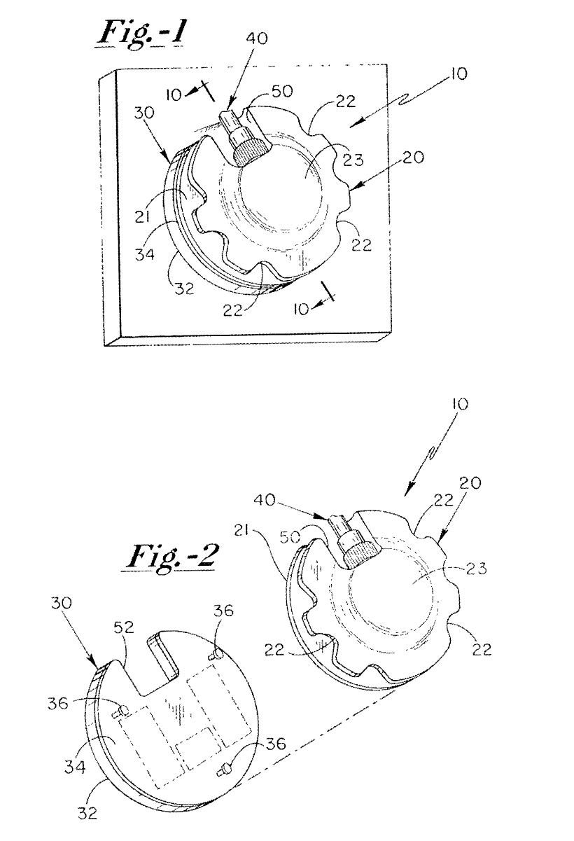

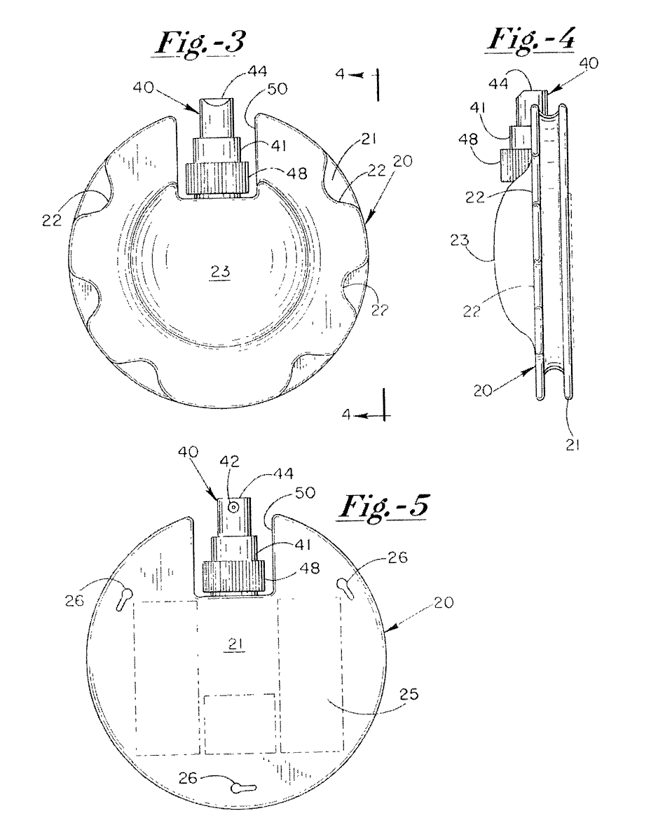

As shown in FIG. 1, the device 10 comprises a reservoir, generally shown at reference number 20, a cleaning assembly attached to the reservoir, generally shown at reference number 30, and a dispensing means 40 connected to the reservoir. The reservoir 20 may be molded from any non-corrosive material such as fiberglass, rubber, or plastic. The body of the reservoir is generally dome shaped allowing the palm of the hand to form to the body of the reservoir.

In building one embodiment of the invention, the reservoir is comprised of a dome shaped reservoir top 23 and a reservoir base 21. A fiberglass coat has been used to seal and join the reservoir top and reservoir base, but other substances such as plastic may be used. In another embodiment of the invention, the reservoir top 23 and reservoir base 21 would be constructed as a single unit.

To facilitate a firm grip while utilizing the device, the outside edge of the reservoir has notches 22 sized to receive the fingers of left handed and right handed users. In one embodiment of the invention there are three notches on either side of the dispensing means 40 spaced to anchor the thumb and fingers during left- or right-handed use.

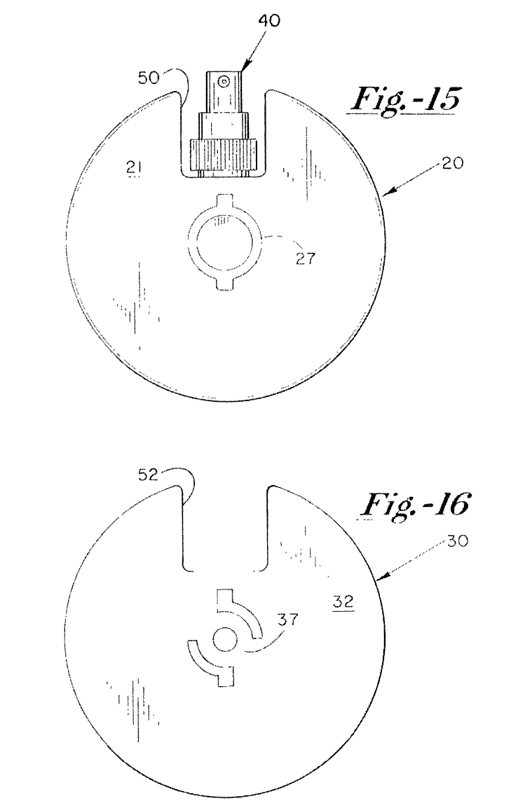

As FIG. 2 illustrates, the reservoir is adapted to receive and constrain a cleaning assembly through the use of fasteners such as bolts, rivets, screws, pins, latches, adhesives, glue, or synthetic materials that adhere when pressed together, commonly sold under the trademark “Velcro.” FIGS. 2, 5, and 6, show an embodiment of the invention where the reservoir base 21 of the reservoir 20 would have female slots 26 of a locking means that would mate in a twist lock fashion with complementary male projections 36 on the connecting surface 34 of the cleaning assembly 30. FIGS. 15 and 16 illustrate another embodiment of the invention where the reservoir base 21 of the reservoir 20 has a male key portion 27 of a locking means that is complementary to a female receiving portion 37 of the locking means on the connecting surface 34 of the cleaning assembly 30. Joining of the reservoir base 21 of the reservoir 20 to the connecting surface 34 of the cleaning assembly 30 can also be achieved by affixing an adhesive or complementary pieces of other fasteners such as “Velcro” to the reservoir base fastening area 25 of the reservoir base 21 and the connecting surface fastening area 35 of the connecting surface 34 of the cleaning assembly 30.

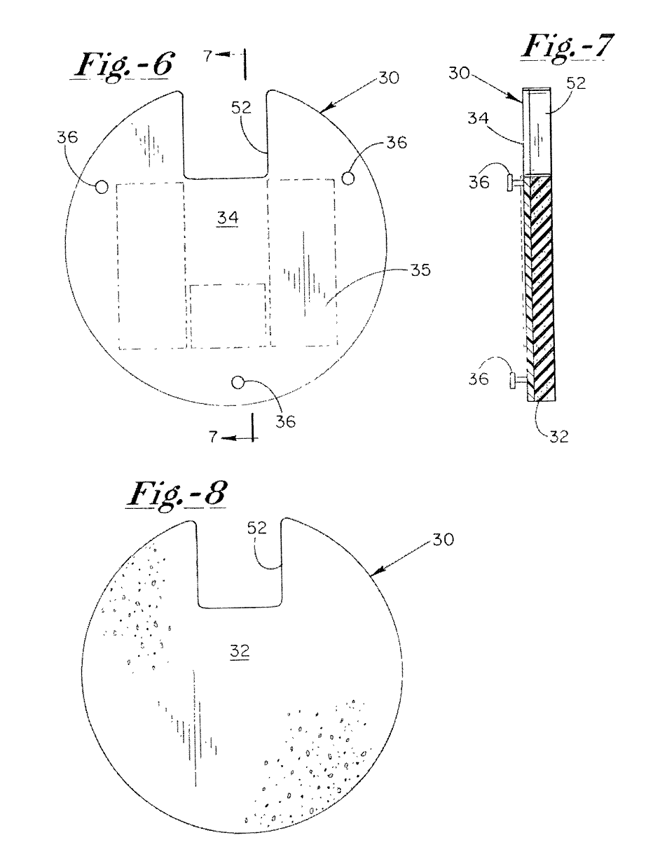

As shown in FIGS. 2, 6, 7, and 8, the cleaning assembly 30 is comprised of a cleaning surface 32 on one side of the cleaning assembly and a connecting surface 34 on the other side of the cleaning assembly. The particular materials selected in the construction of the cleaning surface 32 are dictated by the intended use of the device. The cleaning surface may be comprised of materials such as sponge, foam plastic, flag brush bristles, or coarse scrubbing pads made of steel wool or a harder plastic material such as non-woven plastic filament. FIGS. 6 and 7 show the connecting surface 34 and male projections 36 of a locking means.

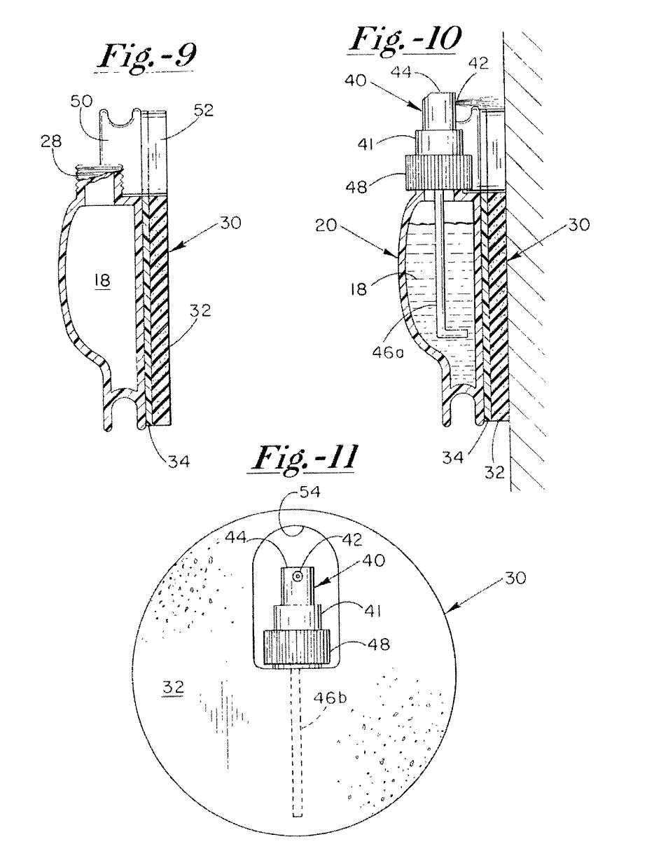

FIGS. 9 and 10 illustrate the dispensing means 40 of the preferred embodiment. The reservoir 20 has a threaded opening 28 that engages a manually operable actuator assembly 41. The actuator assembly is comprised of a nozzle 42, a depressing plunger 44 that is biased in the upward direction by an internal spring (not shown), a tube 46a, 46b which connects the nozzle to the fluid 18 stored in the reservoir, and a cap 48 that sealably engages the reservoir's threaded opening 28. As shown in FIGS. 1 and 2, a reservoir aperture 50 is formed in the shape of a peripheral slot on the reservoir 20 and a corresponding cleaning assembly aperture 52 is formed in the shape of a peripheral slot on the cleaning assembly 30 so the spray from the nozzle may be directed to the surface to be cleaned while making the plunger 44 easily accessible by the user's finger. In addition, the orientation of the nozzle 42 relative to the cleaning surface 32 of the cleaning assembly 30 allows excess fluid from the nozzle to be absorbed by the cleaning surface, thus preventing waste and conserving fluid. This is especially significant when using the device on a vertical surface.

When using the device on a vertical surface, an actuator assembly tube 46b may be chosen that is relatively parallel to the surface to be cleaned. This configuration of the tube gives the actuator assembly access to fluid stored in the reservoir when the fluid level is low. However, when the device is to be used on a horizontal surface, an actuator assembly tube 46a may be selected that bends 90 degrees at its distal end towards the horizontal surface to allow the actuator assembly to access the stored fluid at low levels. This distal end is sized to pass through the reservoir's threaded opening 28.

FIG. 11 shows an alternative embodiment of the invention. In this version, the reservoir aperture 50 and cleaning assembly aperture 52 would essentially surround the spray from the nozzle 42 by 360 degrees and form an opening 54. In this configuration, the fluid is constrained to pass out of the opening 54. In addition, excess fluid that would otherwise be lost to the surrounding air or come into contact with areas not intended by the user would be absorbed by the portion of the cleaning surface that substantially encompasses the spray from the nozzle 42.

Operation of the device 10 is shown by referring to the figures and is as follows. The fluid to be dispensed is placed into the reservoir 20 through threaded opening 28. Next, the user may choose a substantially straight tube 46b (for cleaning a vertical surface) or a tube with a 90 degree bend 46a (for cleaning a horizontal surface) to attach to nozzle 42 of the actuator assembly 40. Then, the actuator assembly is sealably attached to the reservoir by mating the reservoir's threaded opening 28 to the actuator assembly's cap 48. The depressing plunger 44 may be rotated to ensure that the nozzle 42 is pointed in the desired direction while the plunger holds the tube 46a, 46b in an orientation that maximizes access to the fluid stored in the reservoir.

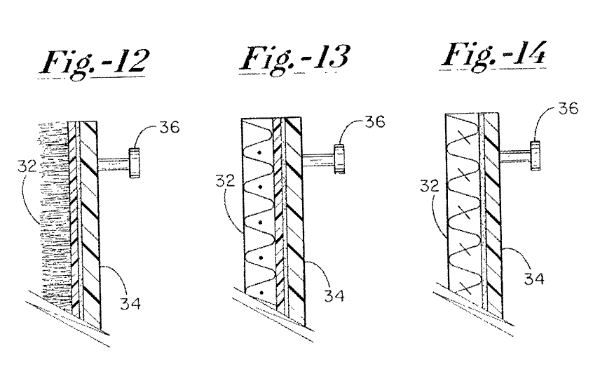

The surface to be cleaned will determine which detachable cleaning assembly 30 with its unique accompanying cleaning surface 32 will be chosen. The reservoir base 21 of the reservoir 20 will mate with and engage the corresponding connecting surface 34 of each cleaning assembly 30. As shown in FIGS. 12, 13, and 14, the user will have a choice of cleaning surfaces such as sponge, wire brush, flag brush, and steel wool.

With the cleaning assembly securely attached to the reservoir, the user may apply the device 10 to the surface to be cleaned and depress the plunger 44 of the actuator assembly 40. The reservoir aperture 50 and the cleaning assembly aperture 52 protect against any fluid going to an area not targeted by the user. In addition, excess fluid will be absorbed by the cleaning surface 32 out of which the cleaning assembly aperture is constructed. Short bursts of the plunger can be made according to need to dispense appropriate amounts of fluid while the user can utilize the cleaning surface of the device to simultaneously wipe and work the fluid into the targeted area without disengaging the device form the surface to be cleaned. This prevents waste due to misdirected spraying and running excess fluid. The device also prevents streaking caused by uneven application and drying of fluid.

The previously described versions of the present invention have many advantages, including:

a) The device is comfortable to use, does not fatigue the hand, and stays secure in the user's palm even when working with slippery cleaning fluids. The device's dome shape conforms to the user's hand while the notches on the device's periphery allow the user to keep a firm grip while working.

b) The device prevents the hand from contact with potentially harmful chemicals found in cleaning fluids.

c) The device prevents the hand from contact with potentially harmful chemicals found in cleaning fluids.

d) The device is compact for it is sized to fit a person's hand. Therefore the device can fit in car glove compartments, desk drawers, backpacks, and other small storage areas. For even more compact storage, the cleaning assembly can detach from the reservoir and be stored separately.

e) The device prevents wasting cleaning fluid as well as streaking. Apertures within the device's reservoir and cleaning assembly allow easy finger operation of the device's plunger while concentrating the sprayed cleaning fluid onto areas intended by the user. The proximity of the plunger to the reservoir and cleaning assembly permits the user to apply the device directly onto the surface to be cleaned and to deliver the cleaning fluid by depressing the plunger. Therefore, the device can be used to apply and work the fluid into the surface to be cleaned in one continuous motion without loss of contact with the surface. This prevents unsightly lines or patches from forming when the surface to be cleaned dries. In addition, fluid that would otherwise be lost to the atmosphere or cause streaking due to runoff is collected by the cleaning assembly.

f) The device has actuator tubes specifically designed for either vertical or horizontal surfaces. For vertical surfaces such as tires, blackboards, and windows, a substantially straight actuator assembly tube can be used. For horizontal surfaces such as table tops, floors, and automobile hoods, an actuator assembly tube that curves 90 degrees towards the surface at its distal end can be chosen to prolong the need to refill the reservoir and to prevent the evaporation of stored fluid that would normally go unused.

The present invention does not require that all the stated features and advantages be incorporated into every embodiment of the invention.

It should be understood that the foregoing description of the invention is intended merely to be illustrative thereof and that other embodiments and modifications may be apparent to those skilled in the art without departing from its spirit.

What is claimed is:

1. An ergonomic, portable, multi-purpose cleaning device of the type for cleaning tires, automobiles, boats, furniture and the like comprising:
a) a reservoir for containing cleaning fluid;
b) a cleaning assembly in fluid communication with said reservoir, said cleaning assembly comprised of at least one cleaning surface;
c) a dispensing means for dispensing fluid contained in the reservoir, said dispensing means connected to said reservoir.

2. The reservoir of claim 1 wherein said reservoir is shaped to conform to a user's hand, the outside edge of said reservoir having at least one peripheral groove therein shaped to receive at least one finger of a user's left or right hand for added control when cleaning.

3. The reservoir of claim 1 wherein at least one side of the reservoir is generally dome shaped to increase the volume of cleaning solution capable of being stored in said reservoir.

4. The reservoir of claims 1, 2, or 3 where said reservoir is further comprised of at least one locking means engagable with at least one corresponding and complimentary locking means on said cleaning assembly.

5. The cleaning assembly of claim 1 wherein said cleaning assembly is detachably fastened on said reservoir.

6. The cleaning assembly of claim 5 where said assembly is further comprised of at least one locking means engagable with at least one corresponding complimentary locking means on said reservoir.

7. The cleaning assembly of claim 5 wherein said cleaning assembly is further comprised of at least one cleaning assembly connecting surface.

8. The cleaning surface of claim 1 or claim 7 wherein said cleaning surface is selected from the group consisting of sponge foam, flag brush bristles, and nylon wool.

9. A method of connecting a detachably fastened cleaning assembly to a reservoir of a cleaning device in proper orientation, comprised of aligning at least one member of a locking means of said reservoir on one side of a connection axis but not the other side with a corresponding and complementary member of said locking means on a cleaning assembly connecting surface of said cleaning assembly, moving said locking means of said reservoir toward the corresponding and complementary locking means of said cleaning assembly connecting surface along said connection axis, mating said locking means on said reservoir with said corresponding and complementary locking means on said cleaning assembly connecting surface, and connecting said reservoir to said cleaning assembly connecting surface.

10. The cleaning device of claim 1 wherein said dispensing means includes a plunger for applying liquid from the reservoir onto the surface to be cleaned.

11. The plunger of claim 10 wherein a tube that extends from an outlet nozzle of said plunger into the reservoir is angled to retrieve a greater amount of liquid when the cleaning device is used on horizontal surfaces, thus prolonging the need for refilling the reservoir.

12. The plunger of claim 10 wherein the distal portion of a tube that extends from an outlet nozzle of said plunger into the reservoir is angled at about 90 degrees towards the surface to be cleaned allowing said pump means to retrieve a greater amount of liquid when the cleaning device is used on horizontal surfaces, thus prolonging the need for refilling the reservoir.

13. The cleaning device of claim 10 wherein said reservoir has at least one peripheral slot therein for finger operation of said plunger.

14. The cleaning device of claim 13 wherein said cleaning assembly has at least one peripheral slot therein, axially aligned with at least one peripheral slot of said reservoir.

15. The cleaning device of claim 14 wherein said dispensing means is proximately positioned near a peripheral slot of said reservoir and a peripheral slot of said cleaning assembly whereby the dispersal of fluid from said dispensing means can be concentrated and directed to the intended surface and excess fluid can be collected by said cleaning assembly.

16. The cleaning device of claim 10 wherein said reservoir has at least one aperture formed therein for finger operation of said plunger.

17. The cleaning device of claim 16 wherein said cleaning assembly has at least one aperture that forms an opening therein, said opening in said cleaning assembly being axially aligned with at least one aperture that forms an opening in said reservoir therein whereby the dispersal of fluid from said dispensing means can be concentrated and directed to the intended surface and excess fluid can be collected by said cleaning assembly.

18. The cleaning device of claim 17 wherein said dispensing means is proximately positioned near an aperture that forms an opening in said reservoir and an aperture that forms an opening in said cleaning assembly whereby the dispersal of fluid from said dispensing means can be concentrated and directed to the intended surface and excess fluid can be collected by said cleaning assembly.

19. A kit for multi-purpose cleaning of the type for cleaning tires, automobiles, boats, furniture and the like comprising:
a) at least one reservoir for containing cleaning fluid, said reservoir shaped to conform to a user's hand, the outside edge of said reservoir's body shaped to receive at least one finger of a user's hand for added control when cleaning;
b) at least one cleaning assembly wherein said cleaning assembly is detachably fastened on said reservoir, said cleaning assembly comprised of at least one cleaning surface and at least one cleaning assembly connecting structure, said cleaning surface is selected from the group consisting of sponge foam, flag brush bristles, and nylon wool;
c) at least one plunger wherein the distal portion of a tube that extends from an outlet nozzle of said plunger into the reservoir is angled at about 90 degrees towards the surface to be cleaned allowing said plunger to retrieve a greater amount of liquid when the cleaning device is used on horizontal surfaces, thus prolonging the need for refilling the reservoir;
d) at least one plunger wherein the tube that extends from an outlet nozzle of said plunger into the reservoir is approximately straight allowing said pump means to retrieve a greater amount of liquid when the cleaning device is used vertically, thus prolonging the need for refilling the reservoir, and;
e) cleaning fluid.

20. The kit for multi-purpose cleaning of the type for cleaning tires, automobiles, boats, furniture and the like of claim 19 wherein said cleaning fluid is a liquid protectorant.

21. The kit for multi-purpose cleaning of the type for cleaning of the type for cleaning tires, automobiles, boats, furniture and the like of claim 20 wherein the liquid protectorant is a silicone-containing composition.

22. The kit for multi-purpose cleaning of the type for cleaning tires, automobiles, boats, furniture and the like of claim 19 wherein said cleaning fluid is a glass cleaner.
